(19) United States
(12) Patent Application Publication
(10) Pub. No.: US 2014/0172542 A1
(43) Pub. Date: Jun. 19, 2014

(54) EVENT BASED ADVERTISEMENT SELECTION

(71) Applicant: Ubimo Ltd., Tel-Aviv (IL)

(72) Inventors: Oded PONCZ, Tel-Aviv (IL); Gilad Amitai, Tel-Aviv (IL); Ran Ben-Yair, Tel-Aviv (IL); Roman Gershman, Rishon-LeZion (IL)

(73) Assignee: Ubimo Ltd., Tel-Aviv (IL)

(21) Appl. No.: 14/133,787

(22) Filed: Dec. 19, 2013

Related U.S. Application Data
(60) Provisional application No. 61/768,637, filed on Feb. 25, 2013.
(60) Provisional application No. 61/739,238, filed on Dec. 19, 2012.

(51) Int. Cl. G06Q 30/02

(52) U.S. Cl. CPC G06Q 30/0252; G06Q 30/0261
USPC 705/14.43; 705/14.5

(57) ABSTRACT

A method for selecting an advertisement (ad) to display in an ad spot, comprising: accessing a database documenting categories, each including at least one event item having geographical coordinates, an event occurrence time parameter and at least one descriptive parameter; receiving at least one theme definition selected for an advertising campaign; matching between the theme definition and at least one relevant category from the categories; assigning an ad from the advertising campaign to the relevant category according to the matching; receiving a message indicative of a location of a user at a specific time from a client terminal associated with the user; finding an event item corresponding to the location and time; selecting an ad from the relevant category which includes the corresponding event item; and sending the client terminal a response to the message, comprising instructions to present the ad on a display of the client terminal.

### RELATED APPLICATION

This application claims the benefit of priority under 35 USC §119(e) of U.S. Provisional Patent Application Nos. 61/739,238 filed Dec. 19, 2012, and 61/768,637 filed Feb. 25, 2013, the contents of which are incorporated herein by reference in their entirety.

### FIELD AND BACKGROUND OF THE INVENTION

The present invention, in some embodiments thereof, relates to an advertisement (ad) selection and, more particularly, but not exclusively, to an event or location based ad selection.

In recent years users spend increasingly large time online via mobile devices such as smartphones and tablets. In addition, online access is also shifting to native applications via popular operating systems such as Apple iOS and Google's Android. As a result traditional web based advertising platforms, built for desktop PC users are adapting to these new environments. New and more effective methods to engage mobile audiences at scale are being developed.

Existing technologies of location based advertising includes hyper-local targeting campaigns where an advertiser selects specific points and areas on a map.

Other technologies are used to collect location history and build a user profile that enables advertisers to target specific location based audiences.

### SUMMARY OF THE INVENTION

According to some embodiments of the present invention there is provided a method for selecting an advertisement (ad) to display in an ad spot, comprising:

accessing a database documenting a plurality of categories, each including at least one event item having geographical coordinates, an event occurrence time parameter and at least one descriptive parameter; receiving at least one theme definition selected for an advertising campaign; matching between the theme definition and at least one relevant category from the plurality of categories; assigning an ad from the advertising campaign to the at least one relevant category according to the matching; receiving a message indicative of a location of a user at a specific time from a client terminal associated with the user; finding an event item corresponding to the location and time; selecting an ad from the at least one relevant category which includes the corresponding event item; and sending the client terminal a response to the message, the response comprising instructions to present the ad on a display of the client terminal.

Optionally, the method initially comprises: monitoring event data acquired from a plurality of sources; analyzing the event data to provide the event items; and defining the plurality of categories according to the event items and assigning the event items to the categories.

More optionally, the monitoring is performed continuously throughout the method.

Optionally, the method further comprises: analyzing ad statistic performance data received from the client terminal; suggesting changes in the at least one relevant category; and updating the at least one relevant category.

More optionally, the updating includes one of removing a relevant category and adding a relevant category.

Optionally, the selecting is optimized according to performance analysis of previously selected ads.

Optionally, the selecting is optimized according to the location and time.

Optionally, the method further comprises: updating the at least one relevant category according to new categories.

Optionally, the categories further include at least one location item having geographical coordinates and at least one descriptive parameter;

Optionally, the categories are arranged in a subject hierarchy according to thematic connections between the categories.

Optionally, the client terminal is a mobile application installed on a mobile device of the user.

Optionally, the client terminal is a browser installed on a mobile device of the user.

According to some embodiments of the present invention there is provided a system for selecting an advertisement (ad) to display in an ad spot, comprising: a category database containing a plurality of categories, each including at least one event item having geographical coordinates, an event occurrence time parameter and at least one descriptive parameter; a campaign database containing at least one relevant category from the plurality of categories matching at least one theme definition of an advertising campaign; and at least one ad from the advertising campaign assigned to the at least one relevant category; a client terminal interface for receiving indicative of a location of a user at a specific time from a client terminal associated with the user corresponding to the at least one location item included in the at least one relevant category and for sending the client terminal a response to the message, the response comprises instructions to present the ad on a display of the client terminal.

Optionally, the system further comprises: an advertiser interface for providing the at least one theme definition by an advertiser.

More optionally, the system further comprises: a categorization module for monitoring and analyzing event data acquired from a plurality of sources to provide the event items; and defining the plurality of categories for the category database.

Optionally, the system further comprises: an optimization module for updating the campaign database according to ad statistic performance data.

More optionally, the system further comprises: a statistics database containing the ad statistic performance data.

Optionally, the system further comprises: a designated module embedded in the client terminal.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

### BRIEF DESCRIPTION OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a flowchart schematically representing a method for selecting an advertisement (ad) to display in an ad spot, according to some embodiments of the present invention; and

FIG. 2 is a system 200 for selecting an ad to display in an ad spot, according to some embodiment of the present invention.

### DESCRIPTION OF EMBODIMENTS OF THE INVENTION

The present invention, in some embodiments thereof, relates to an advertisement (ad) selection and, more particularly, but not exclusively, to an event or location based ad selection.

According to some embodiments of the present invention, there are provided methods and systems of selecting ad to be presented to a user of a mobile device based on the user's location at a certain time. Data is dynamically monitored and analyzed to provide information regarding events at different times and locations.

Categories that include event items and optionally location items, such as a specific shops, venues or concerts, are stored in a category database. An advertiser defines theme definitions of an advertising campaign, such as subjects or concepts related to the advertised product or target audience.

The system analyzes the theme definitions to provide relevant categories and assigns ads from the advertising campaign to the relevant categories. The theme definitions, relevant categories and assigned ads are stored in a campaign database.

A client terminal, such as a publisher having a mobile application, sends a message, such as an ad requests with a user's location at a specific time. The location may be acquired from a user's mobile device and/or derived from the device's internet protocol (IP) address. Messages are received by a client terminal interface from publishers using exchange servers or designated modules embedded in the publisher's application.

An event item corresponding to the user's location and time is found and an ad is selected from a relevant category which includes the corresponding event item. A response that includes instructions to present the ad on a display of the client terminal is then sent by the client terminal interface.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider.

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

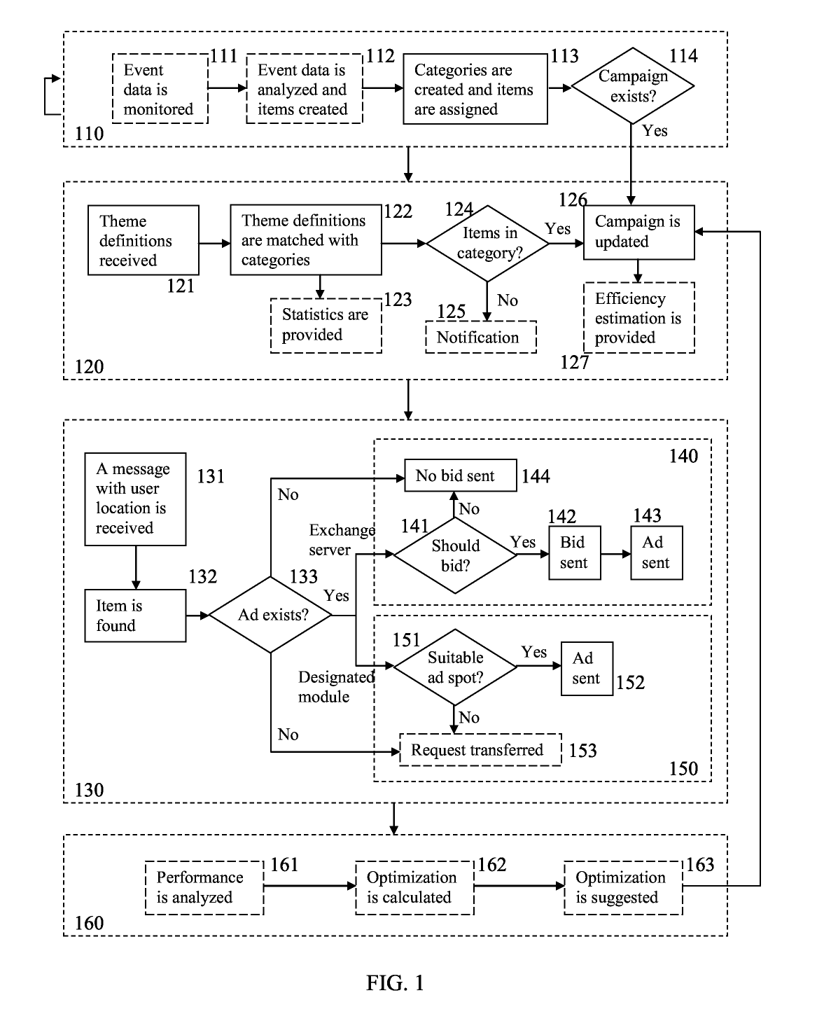

Referring now to the drawings, FIG. 1 is a flowchart schematically representing a method for selecting an advertisement (ad) to present in or in association with an ad spot by matching between campaign theme, event data and user location, according to some embodiments of the present invention. For brevity, an ad spot is used to recite any content carrier, for example a part of a web document, such as a webpage, a media file, and/or an application, a notification, a pop up, augmented realty overlay and/or embedded data, a promotional SMS, a promotional instant messaging message, a promotional call, a video and/or search results on top different client platforms including browsers, mobile devices and television device.

First, as shown in 110, categories are provided, the categories including event items and optionally location items. The event items include geographical coordinates, an event occurrence time parameter and at least one descriptive parameter. For example, a record describing an event item includes the following fields: latitude, longitude, stating time, ending time, event type, organizer and/or formal name.

Optionally, as shown in 111, event data acquired from a plurality of sources is monitored. Then, as shown in 112, event data is analyzed to provide event items. The event items are specific entities existing in a location and time, for example a specific rock concert, soccer game, marketing event, a sale, a demonstration, a visit of a certain group in a location, for example a group of tourists, and/or festival. Optionally, location items are also included in the categories. The location items are specific entities existing in a location, for example “Jim's restaurant”, “East end elementary school”, or any other specific place such as a concert venue, car repair shop, university, flower shop, shopping mall or office building. Optionally, each location item includes a latitude parameter, a longitude parameter and/or a descriptive parameter. The latitude and longitude parameters contain the physical location of the item and the name parameter contains, for example, the specific shop's name. Each event item also includes an event occurrence time parameter.

The data of location and event items may be acquired from many sources, for example, OpenStreetMap, NGA GEOnet Names Server (GNS), various event ticket vendors and/or any other source. The data is analyzed to find related subjects or physical proximity of the items. The analysis may be performed, for example, by an algorithm included in a computer program.

Then, optionally, as shown in 113, categories are created and items are assigned to the categories according to the analysis. Categories may be, for example, “Italian restaurants”, “elementary schools” or “gyms”. The categories are arranged in taxonomy-like subject hierarchy built according to concepts of the real world. For example, a “music concert” category may have “jazz concert” and “rock concert” as sub-categories. Items are assigned to the categories according to the subjects. Optionally, an item is included in multiple categories. For example, the item “Jim's restaurant” may be included in both “Italian restaurants” and “restaurants in New York”.

Optionally, categories arranged in a subject hierarchy according to thematic connections between categories. For example, the categories “Culture centers”,

“Museums” and “Arcades” are sub-categories of the category “Art & Entertainment”, and the categories “Art museums”, “History museums”, “Planetariums” and “Science museums” are sub-categories of the category “Museums”.

Optionally, items are assigned to the categories according to the subject hierarchy. Optionally, conceptual distance of each category from each other category is calculated. The conceptual distance represents how related are the subject of the two categories. For example, the conceptual distance between the category “schools” and the category “universities” is smaller than the distance between the category “schools” and the category “factories”.

The category providing 110 may be performed continuously. Categories and/or items may be inserted, updated, moved and/or removed. Also, conceptual distances between categories may be updated. Optionally, as shown in 114, when an existing advertising campaign exists that uses the categories, the advertising campaign is updated according to new or updated categories and items.

Then, as shown in 120, an advertising campaign is defined. The advertising campaign is a collection of definitions provided by an advertiser wishing to advertise to users. The advertising campaign may include, for example, the scope of the advertising, the desired target audience and/or the budget of the advertising.

First, as shown in 121, theme definitions of the advertising campaign are received from the advertiser of the advertising campaign. The theme definitions are keywords and/or concepts related to the desired target audience of the advertising campaign. Optionally, the theme definitions are related to the advertised product. For example, when the product of the advertising campaign is sports equipment, theme definitions may be “gyms”, “sport resorts” and/or “sport shops”.

Then, as shown in 122, theme definitions are matched with relevant categories from the provided categories. The matching may be performed, for example, by an algorithm included in a computer program. Categories with the closest possible subject to the theme definitions are selected as relevant categories. For example, for the theme definitions “Rock”, “Rock and Roll” and “R&B”, the relevant categories may be “Rock venues”, “Rock concerts” and “Rock Festival”. Optionally, subject hierarchy of the categories is used for the matching. Optionally, the relevant categories are suggested to the advertiser for confirmation. The advertiser may confirm some or all of the suggested relevant categories.

Optionally, as shown in 123, statistics are provided of the theme definitions and relevant categories, for example, of popular or missing categories. This may be used, for example, to optimize the selection of relevant categories in future analysis.

Then, as shown in 124, when items exist in the relevant categories, the advertising campaign is updated and ads are assigned to the relevant categories, as shown in 126. Optionally, as shown in 125, when no items exist in the relevant categories, a notification is presented to the advertiser, allowing the advertiser to select different relevant categories or change the theme definitions.

The ad may be any type of promotional content, for example, in-stream ad(s), such as video and/or audio clip(s), for example pre-roll, mid-roll, and/or post-roll, video overlays, for example interactive small web format (SWF) file that allows adding additional functionality to a displayed content (i.e. clicking the overlay pops up a browser window directed to a selected address), interactive user interfaces, for example a share button that allows users to share the content, banner, text content and/or an audible overlay that is added to an audio file and/or to the soundtrack of a multimedia file. The promotional content may also include ad bundles (combination of several ads in a session such as pre-roll, overlay, re-roll, post-roll etc.), skip ad and/or minimize and restore ads options, engagement monitoring, user unique capping restriction and/or banner companions.

Optionally, as shown in 127, estimation of the efficiency of the advertising campaign is provided to the advertiser based on previous advertising campaigns statistics and categories popularity statistics. Optionally, performance goals are defined for the advertising campaigns, such as click-through rate (CTR), view-through rate (VTR), conversion to event rate and/or delivery rate.

Optionally, the advertising campaign includes an automatically assigned control group experiment where that runs on other type of categories. Control groups enable better context expansion capabilities, improves learning and optimization module and can result in performance prediction based on actual performance and not just based on accumulated data per category.

Then, as shown in 130, an ad is selected and presented in response to a received message indicative of a location of a user at a specific time.

First, as shown in 131, message indicative of a location of a user at a specific time, such as an ad request with location, is received from a client terminal associated with the user. Optionally, the client terminal is a publisher which is an owner of a mobile application and/or website that has embedded ads. Optionally, the location is a location of a user of a mobile device retrieved by the publisher's mobile application from the global positioning system (GPS) of the mobile device. Optionally, the location is retrieved from the mobile network used by the mobile device. Optionally, the location is retrieved from actions made by the user, such as buying a ticket to a concert or requesting directions to an address. Optionally, the location is derived from the device's IP address.

Optionally, the client terminal is an exchange server used by the publisher. Optionally, the message is received directly from the client terminal using a designated module embedded in the publisher's application and/or website.

Then, as shown in 132, an event item corresponding to the location of the user at the specific time is found. Optionally, several items matching the location of the ad request are found, items of proximate location to the location of the ad request are found and/or items included in categories with a small conceptual distance to the matching item's category are found. The matching process may be performed, for example, by an algorithm included in a computer program. Optionally, the subject hierarchy of the categories is used by the algorithm. A category matching the location of the user at the specific time is found, and parent categories are searched for other items matching the location, according to the subject hierarchy.

Then, as shown in 133, an ad, assigned to a category or categories containing the corresponding item(s), is selected. Optionally, several ads are found, and one of the ads is chosen, for example, by an optimization algorithm. For example, an ad with the highest probability to achieve the advertiser's definitions in the advertising campaign is selected by a machine learning mechanism based on parameters such as location, time, user details and/or device details of the current message.

Optionally, as shown in 140, the publisher uses an exchange server with a real-time bidding (RTB) process. When the ad spot is suitable for the advertising campaign, as shown in 141, for example according to budget, mobile device type, mobile carrier, publisher identity and/or type of promotional content, a bid price is set and the bid is sent to the exchange server with instructions to present the ad on a display of the client terminal, as shown in 142. Optionally, the ad is sent to the publisher to be presented to the user, as shown in 143. When the ad spot is unsuitable for the advertising campaign, a different ad assigned to a category containing a matching item is chosen, or no bid is sent as shown in 144.

Optionally, as shown in 150, the publisher uses a designated module embedded in the publisher's application and/or website. When the ad spot is suitable for the advertising campaign, as shown in 151, a response with instructions to present the ad on a display of the client terminal is sent to the designated module. Optionally, the ad is sent to be presented to the user, as shown in 152. Optionally, when the ad spot is unsuitable for the advertising campaign, the ad request is transferred by the designated module embedded to other ad servers or processes, as shown in 153. Optionally, when the ad spot is unsuitable for the advertising campaign, a different ad assigned to a category containing a corresponding item is chosen.

Then, optionally, as shown in 160, optimization is performed. First, as shown in 161, performance is analyzed. Optionally, each ad presented is analyzed using several parameters such as context, publisher and/or time of day. Optionally, for each parameter, views, clicks, engagement and/or actions performed by the user are analyzed. Then, as shown in 162, optimization is calculated according to the analysis. Optionally, a set of parameter values that correspond with better performance according to the performance goals for the advertising campaign are identified. The optimization may include proposed adjustments, for example, limiting the locations to specific areas such as specific neighborhoods within a city; expanding or narrowing the context of the advertising campaign such as by adding relevant categories or removing underperforming categories; and/or adjusting bid prices such as bidding less for ad spots less likely to result in a desired event. Optionally, optimization's proposed adjustments are suggested to the advertiser, as shown in 163. Optionally, the advertising campaign is configured to apply optimizations automatically, and advertising campaign is updated automatically according to the proposed adjustments, as shown in 126.

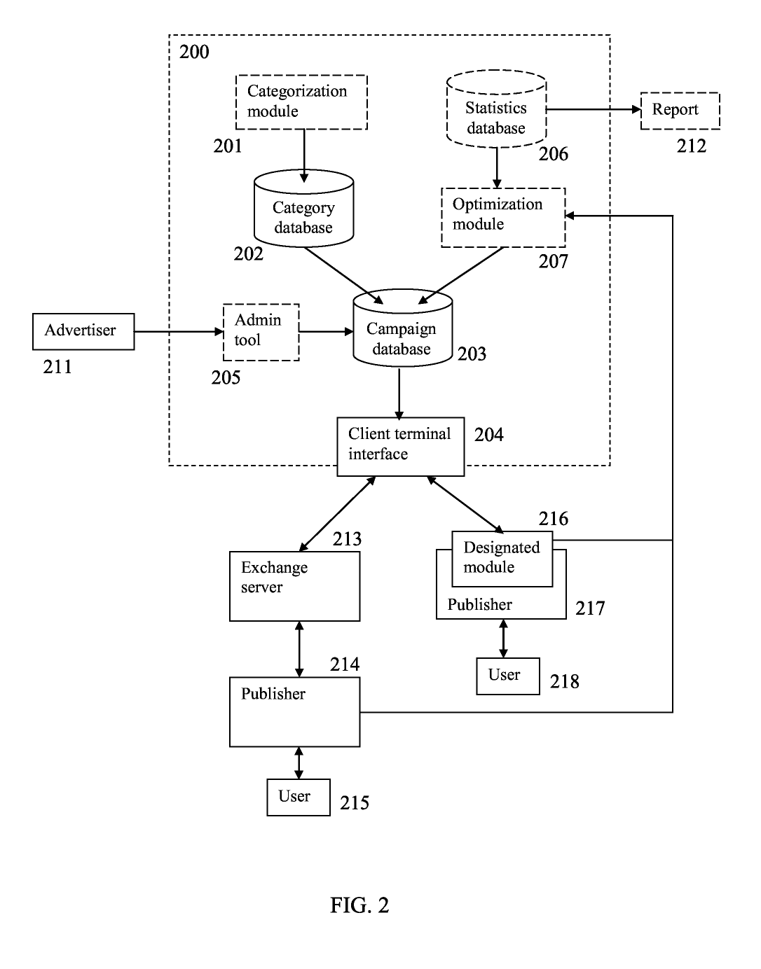

Reference is also made to FIG. 2, which is a system 200 for selecting an ad to display in an ad spot, according to some embodiment of the present invention. The system is optionally implemented on one or more network servers.

System 200 includes a category database 202 containing categories, each including event items. Each event item has geographical coordinates, an event occurrence time parameter and at least one descriptive parameter. Optionally, system 200 also includes a categorization module 201 for monitoring and analyzing event data acquired from a plurality of sources to provide the event items, defining the categories for category database 202 and assigning the event items to the categories.

System 200 also includes a campaign database 203 containing relevant categories from the categories stored in category database 202 that matches theme definitions of an advertising campaign and ads from the advertising campaign assigned to the relevant category.

System 200 also includes a client terminal interface 204 for receiving messages indicative of locations of users at specific times from a client terminals associated with the users and for sending a response to the message with instructions to present the ad on a display of the client terminal to the user.

Optionally, when the client terminal is a publisher 214 that uses exchange server 213, publisher client terminal 204 handles ad requests received from exchange server 213, decides to bid for the ad spot, determines value, and sends bid to exchange server 213 with the ad to be presented to user 215 by publisher 214.

Optionally, when the client terminal is a publisher 217 that uses a designated module 216 embedded in the publisher's application and/or website, client terminal interface 204 connects designated module 216 to campaign database 203, and sends the ad to designated module 216 to be presented to user 218.

Optionally, system 200 also includes an advertiser interface 205 for providing the theme definition and any other advertising campaign definitions by advertiser 211.

Optionally, system 200 also includes an optimization module 207 for updating campaign database 203 according to ad statistic performance data. Optionally, system 200 also includes a statistics database 206 containing the ad statistic performance data provided to optimization module 207. Optionally, data of ad performance is transferred from publisher 214 and/or designated module 216 to optimization module 207 to be used in the optimization process.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It is expected that during the life of a patent maturing from this application many relevant location based ad selection will be developed and the scope of the term ad selection is intended to include all such new technologies a priori.

The terms “comprises”, “comprising”, “includes”, “including”, “having” and their conjugates mean “including but not limited to”. This term encompasses the terms “consisting of” and “consisting essentially of”.

The phrase “consisting essentially of” means that the composition or method may include additional ingredients and/or steps, but only if the additional ingredients and/or steps do not materially alter the basic and novel characteristics of the claimed composition or method.

As used herein, the singular form “a”, “an” and “the” include plural references unless the context clearly dictates otherwise. For example, the term “a compound” or “at least one compound” may include a plurality of compounds, including mixtures thereof.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

What is claimed is:

1. A method for selecting an advertisement (ad) to display in an ad spot, comprising:
accessing a database documenting a plurality of categories, each including at least one event item having geographical coordinates, an event occurrence time parameter and at least one descriptive parameter;
receiving at least one theme definition selected for an advertising campaign;
matching between said theme definition and at least one relevant category from said plurality of categories;
assigning an ad from said advertising campaign to said at least one relevant category according to said matching;
receiving a message indicative of a location of a user at a specific time from a client terminal associated with said user;
finding an event item corresponding to said location and time;
selecting an ad from said at least one relevant category which includes said corresponding event item; and
sending said client terminal a response to said message, said response comprising instructions to present said ad on a display of said client terminal.

2. The method of claim 1, initially comprising:
monitoring event data acquired from a plurality of sources;
analyzing said event data to provide said event items; and
defining said plurality of categories according to said event items and assigning said event items to said categories.

3. The method of claim 2, wherein said monitoring is performed continuously throughout said method.

4. The method of claim 1, further comprising:
analyzing ad statistic performance data received from said client terminal;
suggesting changes in said at least one relevant category; and
updating said at least one relevant category.

5. The method of claim 4, wherein said updating includes one of removing a relevant category and adding a relevant category.

6. The method of claim 1, wherein said selecting is optimized according to performance analysis of previously selected ads.

7. The method of claim 1, wherein said selecting is optimized according to said location and time.

8. The method of claim 1, further comprising:
updating said at least one relevant category according to new categories.

9. The method of claim 1, wherein said categories further include at least one location item having geographical coordinates and at least one descriptive parameter.

10. The method of claim 1, wherein said categories are arranged in a subject hierarchy according to thematic connections between said categories.

11. The method of claim 1, wherein said client terminal is a mobile application installed on a mobile device of said user.

12. The method of claim 1, wherein said client terminal is a browser installed on a mobile device of said user.

13. A system for selecting an advertisement (ad) to display in an ad spot, comprising:
a category database containing a plurality of categories, each including at least one event item having geographical coordinates, an event occurrence time parameter and at least one descriptive parameter;
a campaign database containing at least one relevant category from said plurality of categories matching at least one theme definition of an advertising campaign; and at least one ad from said advertising campaign assigned to said at least one relevant category; and
a client terminal interface for receiving indicative of a location of a user at a specific time from a client terminal associated with said user corresponding to said at least one location item included in said at least one relevant category and for sending said client terminal a response to said message, said response comprises instructions to present said ad on a display of said client terminal.

14. The system of claim 13, further comprising:
an advertiser interface for providing said at least one theme definition by an advertiser.

15. The system of claim 13, further comprising:
a categorization module for monitoring and analyzing event data acquired from a plurality of sources to provide said event items; and defining said plurality of categories for said category database.

16. The system of claim 13, further comprising:
an optimization module for updating said campaign database according to ad statistic performance data.

17. The system of claim 16, further comprising:
a statistics database containing said ad statistic performance data.

18. The system of claim 13, further comprising:
a designated module embedded in said client terminal.
